(19) United States
(12) Patent Application Publication
(10) Pub. No.: US 2005/0253459 A1
(43) Pub. Date: Nov. 17, 2005

(54) Rotary energy conversion device

(76) Inventor: Francis W. Cole, Tucson, AZ (US)

Correspondence Address: QUARLES & BRADY STREICH LANG, LLP, ONE SOUTH CHURCH AVENUE, SUITE 1700, TUCSON, AZ, 85701-1621, US

(21) Appl. No.: 10/845,751

(22) Filed: May 14, 2004

(51) Int. Cl. B60L 3/00

(52) U.S. Cl. 307/10.1

(57) ABSTRACT

An energy conversion device is used to capture energy from vehicles in a roadway and produce electric energy. This energy is distributed to homes, businesses, or government facilities through an electric distribution network. A shaft or flywheel is placed in a roadway with a portion exposed so as to come in contact with tires of passing vehicles. Kinetic energy is transferred from the vehicle's tires to the shaft which, in turn, powers an electric generator. The resulting electricity is delivered to homes, business, or government facilities through an electric distribution system.

### BACKGROUND OF THE INVENTION

1. Field of the Invention

This invention is related in general to the field of energy conversion systems. In particular, the invention consists of a device for capturing mechanical energy from motorized vehicles and producing electrical energy.

2. Description of the Prior Art

It is well known in the art that mechanical energy can be converted to electrical energy using electric generators. A mechanical power source is often used to rotate a shaft that, in turn, rotates one or more coils of wire through a magnetic field producing electric current. Or, a magnet could be rotated through one or more coils to produce this electric current.

One example of this principal is an electric power generation plant. Once electric energy has been generated, it must be routed to end users through a distribution network of electric poles and underground wires. The delivered electric power can be used to power electrical devices in homes and businesses.

Traditional sources of power are coal, oil, and nuclear energy. However, these power sources pollute the environment and are detrimental to our ecosystem. Additionally, there are finite amounts of the resources necessary to produce these types of energy and they will eventually be depleted. Renewable and earth-friendly power sources that are non-polluting and have limited impact on the environment include wind, solar, surf, and geo-thermal. However, development of these energy sources is expensive and, as yet, not cost-effective. Accordingly, it would be advantageous to have a source of energy which is non-polluting, replenishable, and cost-effective.

### SUMMARY OF THE INVENTION

The invention disclosed herein is an energy conversion system that captures energy from vehicles in a roadway and converts it to electric energy. This electric energy can be distributed to homes or businesses through an electric distribution network.

One aspect of this invention is that minute amounts of energy are captured from a large number of vehicles. In this manner, the cost of producing the energy captured by the system is spread among a large number of vehicle operators. This might be feasible in remote locations where electric power is needed for an isolated home, business, or government facilitate and the cost of extending an existing distribution network or building a generating plant is prohibitively high. Or, the capture of this energy from vehicles may be seen as a toll for the use of the roadway.

Another aspect of this invention is that it may be used to beneficially reduce the speed of vehicles traveling down hill. Under normal circumstances, a vehicle operator would apply brake pads or disks to rotors creating friction that converts kinetic energy into heat. This process produces extremely high temperatures at the contacting surfaces and eventually wears these surfaces to the point that they must be replaced. Additionally, the heat is transmitted to the air surrounding the vehicle in a non-productive manner. Put simply, the kinetic energy removed from the vehicle is wasted. If, however, this energy was captured in a way that it could be used to rotate a shaft or flywheel, electric energy could be generated.

This can be accomplished by placing a shaft or flywheel in the road surface, with only a portion of the shaft being elevated above the plane of the road. Vehicles traveling over the shaft impart kinetic energy that is converted into electric energy.

Various other purposes and advantages of the invention will become clear from its description in the specification that follows and from the novel features particularly pointed out in the appended claims. Therefore, to the accomplishment of the objectives described above, this invention comprises the features hereinafter illustrated in the drawings, fully described in the detailed description of the preferred embodiments and particularly pointed out in the claims. However, such drawings and description disclose just a few of the various ways in which the invention may be practiced.

### BRIEF DESCRIPTION OF THE DRAWINGS

FIG. 1 is an illustration of a rotary energy conversion system in accordance with the invention including an energy capture device, an electric generator, and an electric distribution system.

FIG. 2a is a perspective view of two energy capture devices mechanically coupled.

FIG. 2b is a top view of two energy capture devices mechanically coupled.

FIG. 3 is a perspective view of an electric generated coupled to an energy capture device by a transmission.

FIG. 4 is a perspective view of multiple energy capture devices mechanically coupled together.

FIG. 5 is a perspective view of multiple electric generators mechanically coupled together.

### DESCRIPTION OF THE PREFERRED EMBODIMENTS

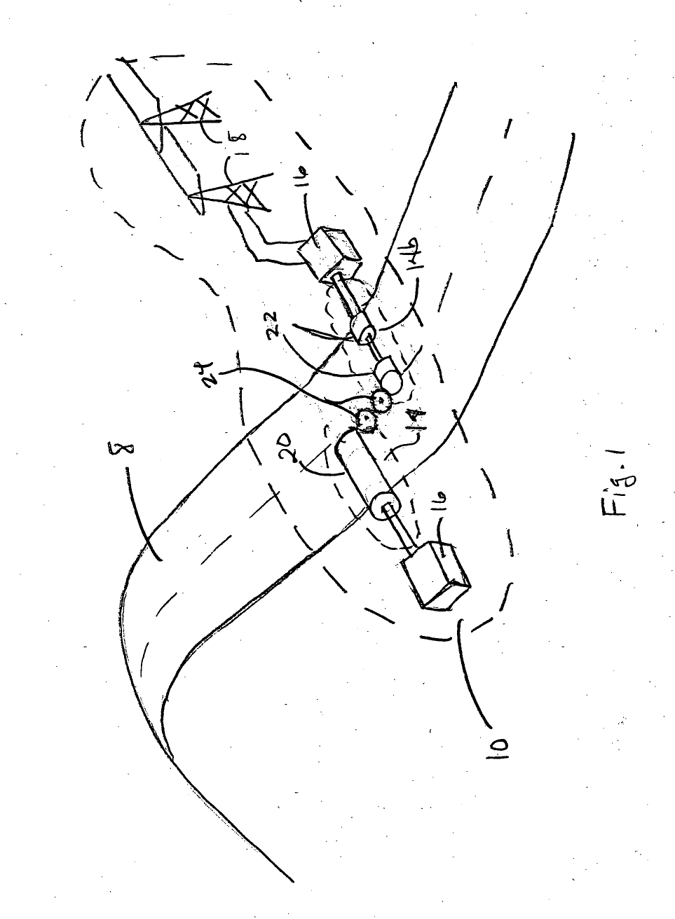

This invention is based on the concept of capturing energy from vehicles in a roadway and converting it to electric energy. This energy is then distributed to homes, businesses, or government facilities through an electric distribution network. Referring to the figures, wherein like parts are designated with the same reference numerals and symbols, FIG. 1 is an illustration a roadway 8 and a rotary energy conversion system 10 including an energy capture device 14, an electric generator 16, and an electric distribution system 18.

The roadway 8 can be any surface intended as a path for vehicles such as automobiles, semi-tractor trailers, and motorcycles to drive over. A roadway with a high number of vehicles traveling at high rates of speed is conducive to the energy conversion system 10 producing a large amount of electricity. But, the invention may be used with any road that has vehicle traffic.

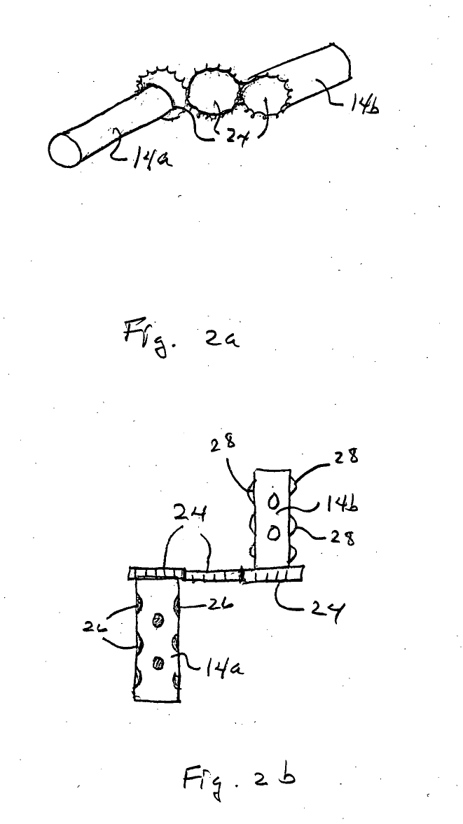

The energy capture device 14 may include a large shaft 20 extending the width of the portion of the roadway wherein traffic is moving in the same direction. Or, one or more flywheels 22 may be used. A separate rotary energy conversion device 14b may be placed on the opposite side of the road to capture energy from vehicles traveling in the opposite direction. Or, shafts rotating in opposite directions due to opposing flows of traffic may be connected with gears 24 so that their captured energies cumulatively drive a common generator 16. An example of this type of coupling is illustrated in FIGS. 2a, 2b.

The shaft 20 of the energy capture device 14 may be a smooth surface, a semi-smooth surface, or a rough surface. Rough surfaces may be produced using tacky, porous, or abrasive materials. Additionally, holes 26 or dimples 28 (FIG. 2) may be placed along the surface of the shaft to increase its gripping force.

The benefit of a rough shaft surface is that a high coefficient of friction is produced between the energy capture device and tires of passing vehicles, increasing the amount of energy transferred to the shaft. However, if the surface of the shaft is traveling at a speed considerably different than that of the traveling surface of a vehicle's tires, a dramatic change in vehicle velocity may result. This may produce a jolt, possible injuring the vehicle's occupants or damaging the vehicle. A shaft 20 with a high coefficient of friction is best suited for roadways with large numbers of vehicles traveling at a fairly consistent rate of speed.

A smooth surface of the shaft 20 would reduce the energy transfer between a vehicle's tire and the rotary energy conversion device 10. This is beneficial when the shaft may not be rotating prior to the vehicle's tires coming into contact with it or may be rotating so that its surface is rotating at a significantly different velocity than the traveling surface of the tire. A smooth or semi-smooth surface may be beneficial for use in roadways with light traffic or traffic which does not maintain a relatively consistent velocity.

The ability of a vehicle tires to effectively interact with a rotary energy conversion device 10 is directly related to the mass of the shaft 20. A shaft having a large mass possesses a corresponding large inertia that must be overcome in order for the shaft to change its rate of rotation. This means that a large amount of energy is required to bring a shaft having a large mass to a high rate of rotation. But, once a high rate of rotation has been achieved, a shaft with a large mass maintains is rate of rotation better than one with a low mass.

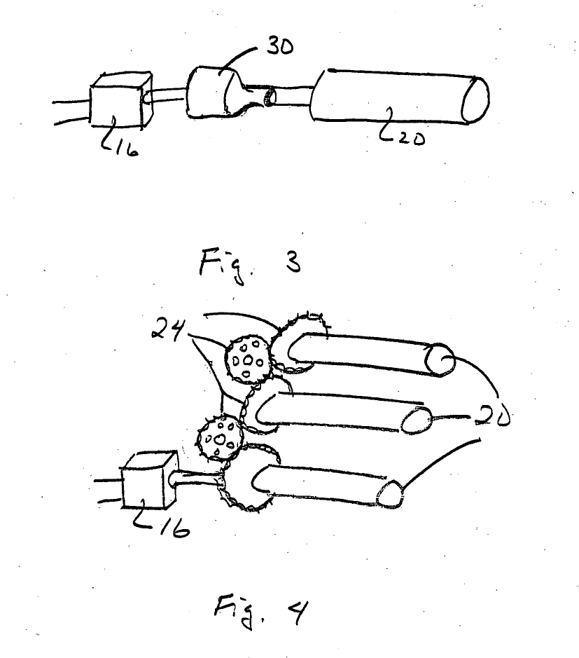

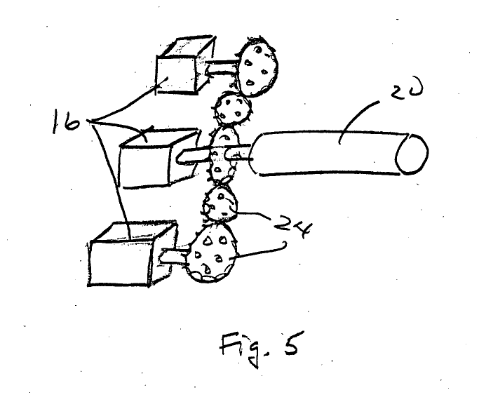

Referring to FIG. 3, a transmission 30 is used to couple the shaft 20 to the electric generator. The benefit of using the transmission is that the generator may rotate at a fairly consistent rate of speed while the rotational velocity of the shaft increases or decreases with the varying flow of traffic. In FIG. 4, multiple shafts 20 have been mechanically coupled to increase the amount of captured energy.

FIG. 5 illustrates an energy conversion system 10 wherein multiple generators 16 are mechanically coupled. During periods of light traffic, only one generator may be coupled to the energy capture device. However, as traffic picks up, additional generators may be brought on line to convert the additional energy. The mechanical coupling of the multiple generators may be accomplished by engaging gears or transmissions between them.

Those skilled in the art of making energy conversion systems may develop other embodiments of the present invention. For example, the energy capture device 14 may be include ribs or vanes to increase the normal force between the shaft 20 or flywheel 22 and a vehicle's tires. The terms and expressions which have been employed in the foregoing specification are used herein as terms of description and not of limitation, and there is no intention in the use of such terms and expressions of excluding equivalents of the features shown and described or portions thereof, it being recognized that the scope of the invention is defined and limited only by the claims which follow. Other embodiments of the invention may be implemented by those skilled in the art of tracking status information.

1. An energy conversion system, comprising:
an energy capture device; and
a first electric generator connected to the energy capture device;
wherein the energy capture device is placed within a roadway, vehicles travel over said roadway creating a first traffic, tires of the vehicles traveling over the roadway contact and transfer a first kinetic energy to said energy capture device, and said first electric generator converts said first kinetic energy into electric energy.

2. The energy conversion system of claim 1, further comprising an electric distribution network connected to the first electric generator.

3. The energy conversion system of claim 1, wherein the energy capture device includes a first shaft placed orthogonal to the first traffic.

4. The energy conversion system of claim 1, wherein the energy capture device includes a flywheel.

5. The energy conversion system of claim 3, wherein the energy capture device includes a second shaft placed orthogonal to a second traffic traveling over the roadway in a direction opposite to the first traffic.

6. The energy conversion system of claim 1, further comprising:
a second energy capture device; and
a second electric generator connected to the second energy capture device;
wherein a second traffic traveling over the roadway in a direction opposite to the first traffic contacts and transfers a second kinetic energy to said second energy capture device, and said second electric generator converts said second kinetic energy into electric energy.

7. The energy conversion system of claim 5, wherein said second shaft is connected to said first shaft and said second traffic contacts and transfers a second kinetic energy to said second shaft, and said first electric generator converts said second kinetic energy into electric energy.

8. The energy conversion system of claim 3, wherein said first shaft includes a smooth surface.

9. The energy conversion system of claim 3, wherein said first shaft includes a rough surface.

10. The energy conversion system of claim 3, wherein said first shaft includes a surface that contains holes for increasing a coefficient of friction between said first shaft and said tires.

11. The energy conversion system of claim 3, wherein said first shaft includes a surface that contains dimples for increasing a coefficient of friction between said first shaft and said tires.

12. The energy conversion system of claim 1, further comprising a transmission coupling said first electric generator and said energy capture device such that a variation in a rate of rotation of said energy capture device in response to a change in said first traffic produces a smaller corresponding variation in a rate of rotation of said first electric generator.

13. The energy conversion system of claim 1, further comprising a second electric generator, wherein said second electric generator is electively connected to said energy capture device based on a magnitude of the first kinetic energy.

14. The energy conversion system of claim 3, wherein the energy capture device includes a second shaft placed orthogonal to the first traffic and parallel to the first shaft.
